(19) United States
(12) Patent Application Publication
(10) Pub. No.: US 2009/0224508 A1
(43) Pub. Date: Sep. 10, 2009

(54) Lever enhanced pedaling system's frame structure

(76) Inventor: Rashad Na'im Scarborough, Durham, NC (US)

Correspondence Address: Rashad Na'im Scarborough, Apt A8, 411 E. Pilot St, Durham, NC, 27707, US

(21) Appl. No.: 12/321,008

(22) Filed: Jan. 15, 2009

Related U.S. Application Data
(60) Provisional application No. 61/063,412, filed on Feb. 4, 2008.

(51) Int. Cl. B62K 3/02

(52) U.S. Cl. 280/281.1

(57) ABSTRACT

A tubular bicycle frame wherein the mid portion of the frame is elevated above the wheels it is mounted on and free from the conditions of being between them. Furthermore, the frame is designed to accommodate two lever machines that pivot from the rear portion of the frame and pull rearward separate drive sprockets located within the rear vertical tubes of the frame, while each drive sprocket rotates the rear wheel. The frame also has a tube structure configuration that prevents the frame from twisting due to great pulling forces working against the axle of the rear wheel. The frame also is able to accommodate electronic devices due to its wide tubular diameter.

This invention relates to the field of basic frame structures for human propelled bikes.

### BACKGROUND OF THE INVENTION

In the bicycle industry the frame of human propelled vehicles are mostly configured in triangular tube structures which helps support the crank sprocket between the wheels, the seat post cylinder, the stirring cylinder, the rear wheel and the front forks holding the front wheel. Currently, this basic frame structure offers a sound instrumental benefit to the bicyclist, by rigidly holding its mechanical components in place so that a rider may propel him or her self from one point to another. The frame structure of the Lever Enhanced Pedaling System (LEPS) supports its drive train components near its rear portion and within the vertical rear ends of its tubes. Such configuration allows each drive sprocket mounted within the cylinder of the frames rear tubular portion to be rotated by a linear transmission member. Each drive sprocket is mounted to the rear wheel with slip lock connection. Each drive sprocket connected to the rear wheel is mounted centrally within its vertical tube member near its base allowing each sprocket to be rotated by its member drive train assembly on its center, thus maintaining a balance which prevents the levers from flexing horizontally while they are being pedaled.

U.S. Pat. No. 4,077,648 uses a frame with a mid portion that is elevated above its mounted wheels. Furthermore, its frames contour starts from its stirring cylinder horizontally and is then formed in a downward curve which ends at the axle of the rear wheel. What distinguishes this frame from that of the LEPS is that its drive sprockets are not within the tubes of its frame structure, the frames tubes are more narrower than that of the LEPS's and the frontal part of said prior art's tube does not go beyond its stirring cylinder. The prior art's propulsion mechanism utilizes a first class lever, so it is mechanically configured differently from the LEPS's, which uses a second class lever. Thus, both frames are structured differently for accommodating two different classes of lever machines. The repositioning support structure of the prior art, which provide means for each lever to reciprocate is different in that it is located on the right side of the bicycle below the frames tubular structure. The LEPS's repositioning system is above its frame structure, which is designed to have pulley wheels mounted on it so that the reciprocal cable could be pulled back and forth above its tubular foundation.

The Velocipede U.S. Pat. No. 3,834,733 by Harris uses an elevated frame free from the condition of being directly between its two wheels. Its transmission means reciprocates between its two lever machines while they are being pedaled, which is similar to the LEPS's hydraulic assistant propulsion mechanism (Ser. No. 12/291,353).

What distinguishes the Velocipede's frame from that of the LEPS is that it needs a triangular tubular structure that is vertically upright, while the LEPS's tubular triangle structure is more horizontal and its triangular construction utilizes a two point system, which prevents tubular collapse below the seat, where a riders weight is stressed as well as the reciprocal mount plate 12 where the reciprocal cable holding the weight of the rider is mounted on. As long as the tubes are bonded at two points lengthwise 72 and (74 & 76), this bond would not be pivotal, which would prevent the frame from gradually sinking in as opposed to a tubular bond that is held together at one pivotal point. The other bonded joints of the frame could be compared to a bridge that is arched with triangular plates supporting the joints.

Furthermore, the mid portion of the Velocipede's transmission means is routed outside of the bicycles frame, while a great portion of the LEPS's transmission means is routed inside of its tubular frame (Ser. No. 12/291,353 FIG. 2). The latter frame is wide enough in diameter to allow this.

U.S. Pat. No. 4,666,174 (Efros) utilizes a frame having a mid portion that is elevated above the axle of its wheels, while the frame of the LEPS is elevated like wise, but different in form. The frame invented by Efros uses an upright tubular structure that includes a triangular construction from its rear hub to the seat post cylinder. The triangular structure of the LEPS having open through spaces is primarily horizontal and therefore different from the latter prior art. The LEPS's frame does have upright triangular supports, but they are primarily solid plates with no open spaces. The frame by Efros has narrower tubes than that of the LEPS. Furthermore, its tube structure does not extend beyond the stirring cylinder.

In summary, each three stated prior art have differences in frame structure that is blatantly different from the frame of the LEPS, furthermore, they lack the advantage of having a frame wide enough to integrate legible hand operated electronics into the frame of their bicycles and the frontal portion of these frames does not have standard integrated lamps to improve visibility during night riding.

The tubular design in this patent application is based on the mechanical configuration in patent application Ser. No. 12/291,353. Experiments had been conducted on a lighter frame that was planar, composed primarily of sheets of aluminum cut and bent into a frame form that was raised between its wheels. When pressure was applied to one of its pedals, the frame twisted because its structure was not strong enough to support the torque generated from the lever machine. So it was determined that a tubular frame would have more structural strength and not twist significantly while pedaling. With this in mind, a design was configured so that the frames tube diameter would be 2.75″ allowing the stirring cylinder to occupy two bores through the top and bottom surfaces near the front of the frame and welded in place. The frontal portion of the frame leads backwards and stops under the seat. The end of this tube is welded to the center of an aluminum rectangular plate. The plate extends from this welded joint to right and left adjacent tubes to form symmetrical (FIG. 6) joints welded in place. The top end of the plate is formed forward at an angle that directs the grooves of the pulley wheels mounted to this surface towards pulley wheels mounted within the repositioning cylinder suspended below the frame of the bike (Ser. No. 12/291,353 FIG. 5). The front parallel portion of the symmetrical tubes welded to opposite ends (74 & 76) of the plate 12 lead forward at an angle pointing inward that connects to the central tube 30 in welded joints 72. The symmetrical tubes 26 are aligned at a downward slope to the central tube 30, but then are formed to lead vertically downwards just below the shaft of the rear wheel. These two symmetrical joints of a three tubular connection with a plate 12 bracing the wider expansion of the three tubes under the seat, prevents the symmetrical rear vertical tubes from flexing significantly during pedaling.

The vertical portions of each symmetrical tube 26 have a pair of polygonal triangular plates 6 welded vertically to their rear surfaces. Each triangular plate has a bore 24 which accommodates a member fulcrum. Each fulcrum has a member lever machine 70 (FIG. 5) with pivotal connection to it. This basic frame 2 structure is distinguished from conventional frames, in that it does not have an upright diamond shaped structure. The mid portion of the frame is raised above the wheels leading back and descending towards the shaft 64 of the rear wheel. Conventional bicycle frames cannot are free from this condition because their frame structure must descend down from the stirring cylinder to support the crank sprocket, its shaft and pedal assembly. The frame of the LEPS supports right and left lever machines 70 that extend from the rear of the bike. Each mid portion of the these levers are suspended by a member piston/cylinder (FIG. 5) machine and each said machine is connected to the frame 2 by a member pair of triangular plates 10, each being ¼″ in thickness, which are welded outside of the bottom surface of the frame 2 located closely behind the frontal surface of the rear wheel. The piston/cylinder repositioning system is not apart of the frame structure.

Another factor which distinguishes the LEPS's frame from conventional bicycle frames is that its rear vertical tubes must be on center with its lever machines 70 and pedals. The applied force on the pedals must be aligned with its member lever 70 and vertical rear portion of the frame 2 to maintain straight downward pedaling and eliminate lever 70 wobbling. Most bicycles have frame structure widths that are well within the horizontal distance of their pedals, thus making the LEPS's frame automatically wider than conventional bicycle frames. The function of the basic frame structure described is to maintain stiffness while sustaining great stresses from the torque generated from the lever machines 70.

### OBJECTS AND ADVANTAGES

Accordingly, besides the objects and advantages of the LEPS's frame clarified in this patent application, a number of objects and advantages of the present invention are:
(a) The LEPS's frame structure is versatile to material composition, in that the frame can be constructed out of aluminum, titanium or carbon fiber.
(b) The LEPS's frame provides enough space to integrate a frontal head lamp into the leading tube portion of the frame.
(c) The LEPS's frame provides new design opportunities and dimensions not offered from conventional frames having a different structural basis.

### SUMMARY

According to the information presented, the LEPS's frame structure is a tubular structure configured to accommodate two lever machines and neutralize significant twisting due to tremendous torque generated from pedaling.

### DRAWING—FIGURES

FIG. 1 illustrates the right side of the LEPS's frame.

FIG. 2 illustrates the front side of the LEPS's frame.

FIG. 3 illustrates the rear view of the LEPS's frame.

FIG. 4 illustrates a 3 dimensional view of the frames frontal portion.

FIG. 5 illustrates how the LEPS's frame focuses the light beam of its integrated head lamp and how the frame would decrease drag when moving through the air.

FIG. 6 illustrates the top view of the LEPS's frame and a zoomed in section of its integrated multi-touch computer.

FIG. 7 illustrates the frontal bottom portion of the frame and how the pivotal lid is fastened in place.

FIG. 8 illustrates a cut away section of the frames frontal portion which exposes how the lamp is clamped in the frame, how the lamp is turned on and how other components are assembled within this section.

DRAWINGS-Reference Numerals

| | |
|---|---|
| 1 | touch screen computer |
| 2 | frame |
| 3 | time & calendar icon |
| 4 | suspension bores |
| 5 | GPS mapping, web and phone icon |
| 6 | parallel plate |
| 7 | miles per hour icon |
| 8 | joint support |
| 9 | tune download and playback icon |
| 10 | suspension plates |
| 11 | cardiovascular display |
| 12 | reciprocal mount |
| 13 | date display |
| 14 | seat post cylinder |
| 15 | ear phone plug outlet |
| 16 | central joint support |
| 17 | EKG plug outlet |
| 18 | stirring cylinder |
| 20 | drop out slot |
| 21 | MPH display |
| 22 | bearing holder |
| 23 | outside temp display |
| 24 | fulcrum |
| 25 | lamp button |
| 26 | symmetrical tube assembly |
| 27 | pulley wheel bores |
| 28 | seat post wings |
| 30 | central tube assembly |
| 32 | extended hubs |
| 34 | light beam |
| 36 | transmission sprocket |
| 38 | frontal lid |
| 40 | lid screw |
| 42 | lamp cylinder |
| 44 | cable guards |
| 46 | lamp |
| 48 | hex nut |
| 50 | flat head screw |
| 52 | pivotal bore |
| 54 | lid shaft |
| 56 | light bore |
| 58 | button bore |
| 60 | break insulation holders |
| 62 | reverse fulcrum bore |
| 64 | wheel axle |
| 66 | transmission portals |
| 68 | seat post clamp |
| 70 | lever machines |
| 72 | central/symmetrical tube joint |
| 74 | right joint of central plate |
| 76 | left joint of central plate |
| 78 | central tube connection to central plate |

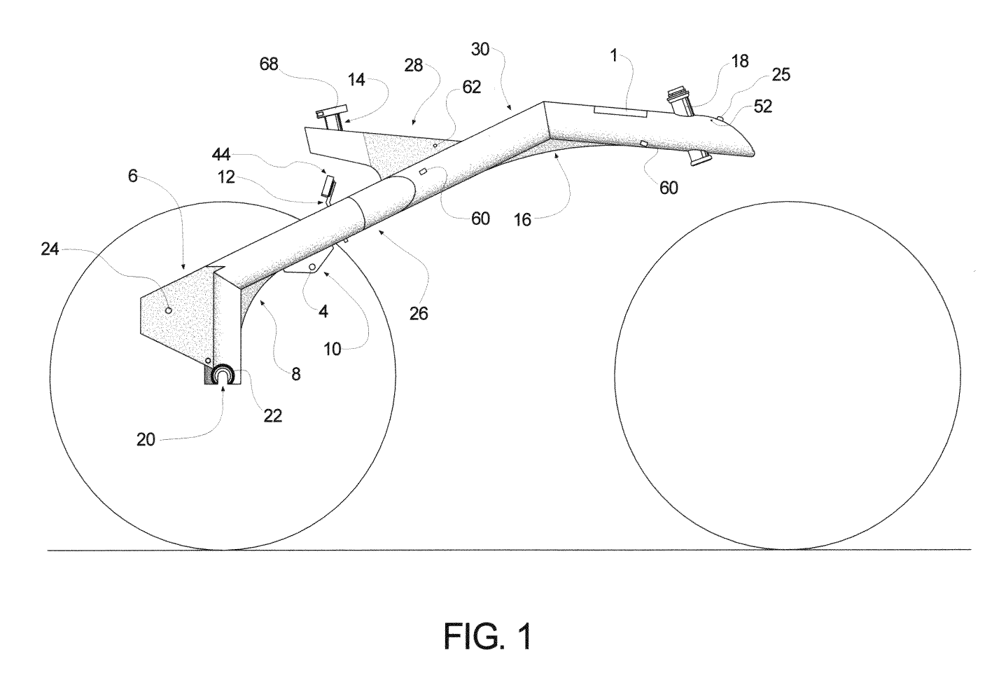

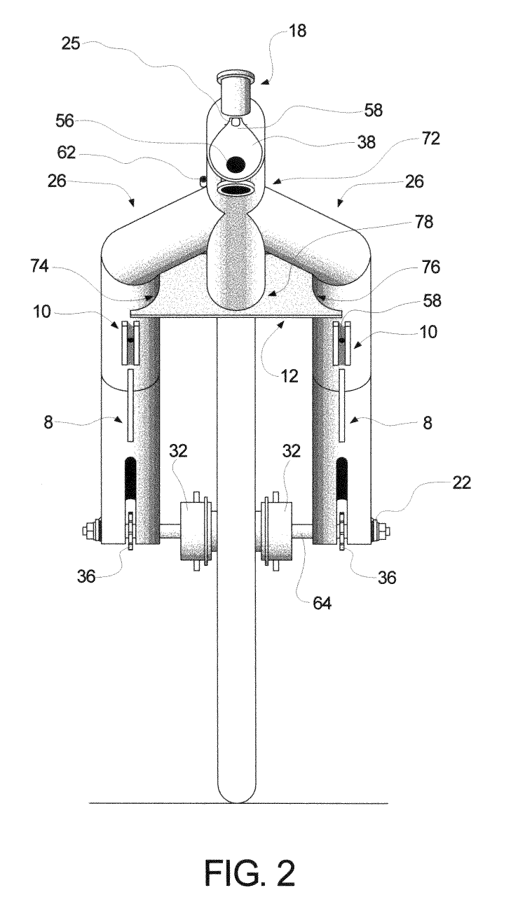

### DETAILED DESCRIPTION—FIGS. 1 TO 3—PREFERRED EMBODIMENT

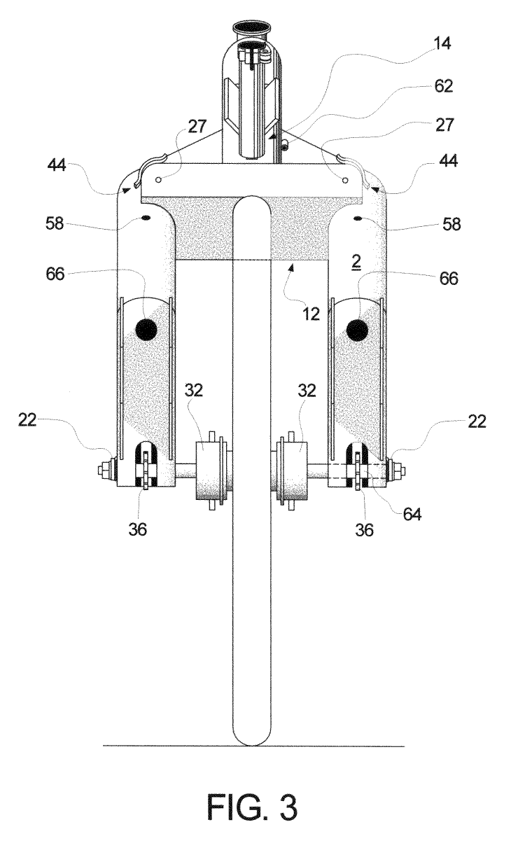

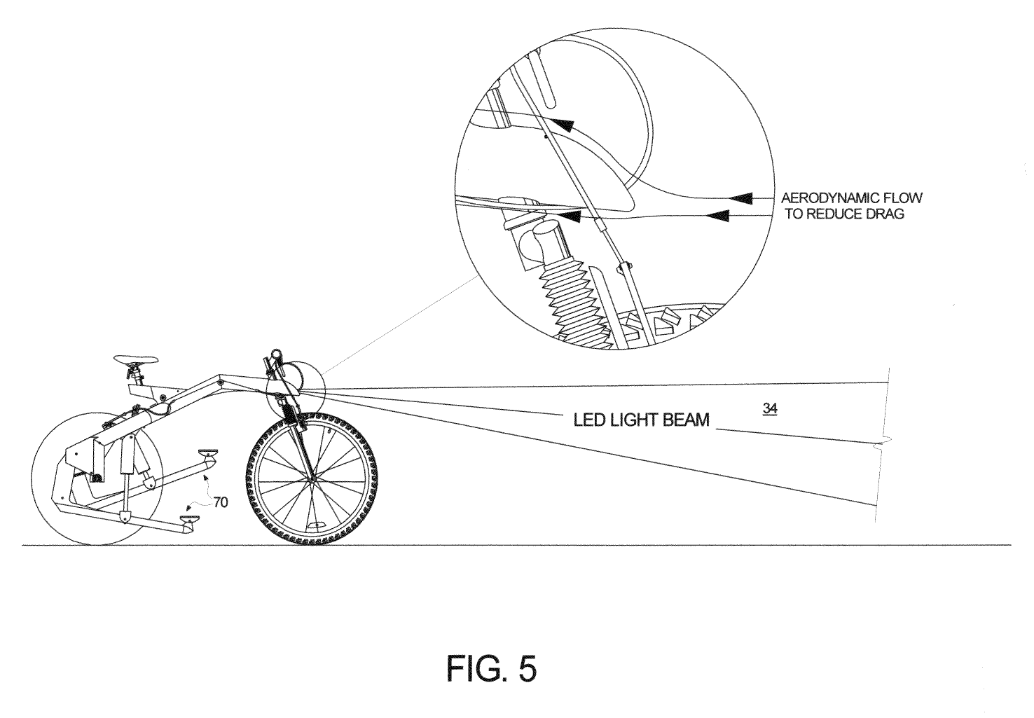

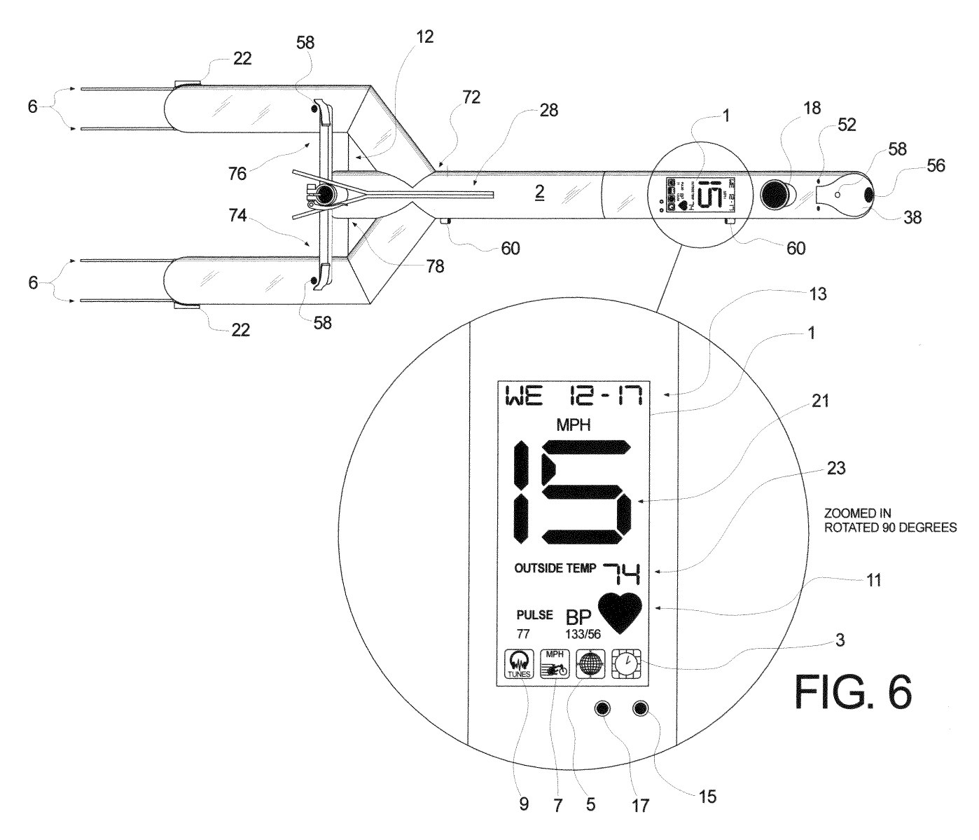

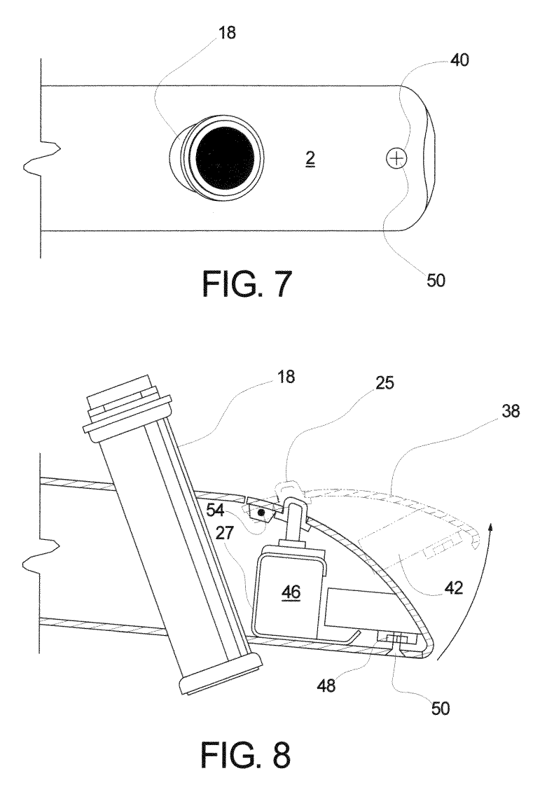

A preferred embodiment of the invention can be illustrated in FIGS. 1-3 and 5-8. The frontal top surface 38 of the frame is composed of a sheet of aluminum or carbon fiber that is formed to close the open front end of the bikes frame 2 and is also formed to be flush with the curved edge of the bikes frame. This curved surface 38 assembly is formed to cut through the wind (FIG. 5) and reduce drag while the bike is moving forward. Underneath the upper edge of the curved plate 38 is a horizontal bore that is through a mass of material protruding from the rear bottom surface of the curved lid 38. This bore accommodates a steel shaft 54 (FIG. 8) which is also through two aligned bores in the frame 52 (FIG. 6), which are on opposite sides of the plates 38 upper edge. This assembly allows the curved lid 38 to pivot around the shaft 54 so that the lid can be lifted upwards to remove the lamp 46 and replace its batteries. The plate 38 has two bores through its top surface. The leading bore 56 has a diameter large enough to let enough light out to illuminate the terrain in front of the bicycle during night riding. The bore behind the former said bore is much smaller which would allow a flexible layer of latex 36 to protrude through the bore and above it to allow the operator of the LEPS to press on the latex button 36 to indirectly switch on the lamp 46 or turn it off. The bigger leading bore 56 has bonded behind it a cylinder 42 which helps focus the lamps beam towards the ground (FIG. 5). Below the surface of this cylinder is a hex nut 48 bonded to its bottom surface. The bore of this nut is aligned to a bore in the bottom surface of the frame 40 (FIG. 7), which is near its frontal edge. A flat head screw 50 is to engage the treads of this bonded hex nut 48 through the leading bore 40 in the frame 2 from the outer bottom of the frame 2 in order to securely fasten the frontal curved lid 38 in place. The flat portion of the screw 50 should be approximately flush with the bottom surface of the frame 2 after it is completely screwed in. In FIG. 1 the frontal area of the frame illustrates how the frames wide diameter accommodates the stirring cylinder 18 welded within the bores of the frontal tube 30 and has a section cut out for a head lamp 46 for night riding. The central tube 30 leads back slightly upwards with an aerodynamic influence (FIG. 5) and then downwards to stop under the seat post 14 of the bike. In FIG. 6, the illustration shows how this end of the central tube 30 is flush to the flat surface of the central plate 12 and welded in place on its center. The central plate 12 is a rectangular aluminum gauge sheet, which extends right and left to connect to adjacent tubes 26, which are symmetrical in form. This connection (74 & 76) is bonded by the tig welding process. The symmetrical tubes 26 begin with a welded connection 72 to the central tube 30. They then lead back outwardly at an angle and then parallel at a slight downward angle. The two symmetrical tubes 26 then form a joint down vertically and stop below the axle 64 of the rear wheel (FIG. 1). The lower portion of these tubes has mounted within them, a member sprocket 36, which rotate duplicate axles 64 (FIG. 3). Each sprocket 36 is connected to a member free-wheel sprocket having slip lock connection to the rear wheel. The edges of each vertical tube have open end dropout grooves 20 allowing the rear axle assembly 64 to drop out for wheel repair (FIG. 1). Adjacently, on the outer surface of each outer dropout groove 20 is an incomplete ring of metal 22 having an opening that is centrally aligned to the open end of the dropout groove 20. These rings 22 bonded to the surface by the welding process and are configured to hold a needle race bearing in place, so as to keep it from slipping below the groove 20 after it has been fastened to the main axel 64 of the rear wheel.

The central plate 12 welded in place between the two symmetrical tubes 26 has an upper end that is formed forward. These ends are bent at an angle, which allow the grooves of the pulley wheels mounted to the rear of its surface to point to the pulley wheels mounted within the cylinder of the repositioning system (Ser. No. 12/291,353 FIG. 5).

### Additional Embodiments

The tubular frame for the LEPS is composed of 5 elements that make up its basic structure. These elements are:
(1) The frontal tubes connection to the stirring cylinder,
(2) the symmetrical tubes direct connection to the central tube,
(3) the central tubes connection to a central plate,
(4) the symmetrical tubes connection to the central plate at a distance behind its connection to the central tube and
(5) the fifth element is the means which allow the duplicate lever machines to pivot and propel the bike, which are the pair of plates bonded to each rear vertical tube having aligned bores which accommodate the fulcrum of its member lever machine.

The first element connects the central tube 30 to the stirring cylinder 18, which is essential for the frame to be connected to the front wheel and fork assembly for stirring purposes. The second element is the symmetrical tubes 26 connection to the central tube 30, which is incomplete without a second point of attachment to the central tube 30, which is the 4^{th} element. Since pivoting usually occurs at one central point, two points of attachment are essential for preventing the pivoting of the symmetrical tubes 26. In order for the 4^{th} element to be effective, the central plate 12 must be held rigidly in place and kept from rotating clockwise or counter clockwise. This is accomplished by aligning the center flat surface of the central plate 12 to the center of the end diameter of the central tube 30 and bonding them together. The wide diameter of the central tube 30 strengthens the rigidness of the central plate 12, because flexion resistance is spread over a larger surface area and tube mass. With these elements in mind, it should be acknowledged that the essential frame elements can be adaptable to different frame forms and be different in proximity to one another.

### Functionality of Components—FIGS. 1 to 3

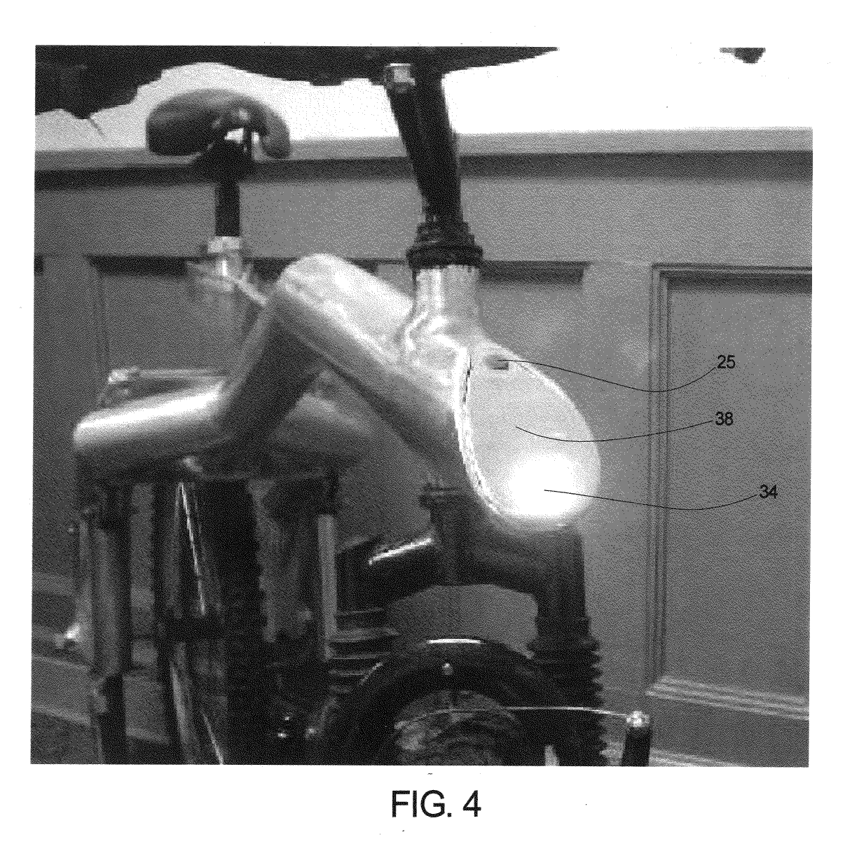

The manner of how each welded component of the frame functions, while operating the vehicle can be illustrated in FIGS. 1 to 5. Firstly, when a pedal is depressed, the lever machines 70 pivots on their member fulcrums attached to separate triangular plates welded 6 to the vertical rear portions of the tubular frame 2 assembled. Being that each plate 6 is welded on center of the vertical tube assembly 26, this prevents significant wobbling of the lever machines 70. Each symmetrical tube assembly 26 is well fixed, by the welding process, at two points along its length to prevent them from flexing during pedaling. The leading point 72 is where the frontal end of each tube assembly 26 is connected to the central tube 30 by the welding process. The second point is where the leading parallel portion of each symmetrical tube assembly 26 is connected, by the welding process, to the aluminum rectangular plate ends (74 & 76). The aluminum plate 12 in turn, is rigidly connected to the central tube 30, in that the end of the central tube 30 is welded centrally to the rectangular plate. The large diameter connection of the central tube to the rectangular plate 12, results in a rigidness that prevents the clockwise and counter clockwise flexion of the rectangular plate 12, which have ends that rigidly brace the lead parallel portion of the symmetrical tubes 30.

Other features of the LEPS's frame structure include the integration of an outdoor lamp 46 within the frame 2 which focuses light in one direction. This lamp 46 would most likely be round in shape which would enable it to fit in the round inner walls of the frames 2 frontal tube. The lamps outer casing surface being circular in form would be parallel to the inner walls of the frames frontal tube. The frontal portion of the frame 2 is pointed slightly downward which would point the cylinder casing of the lamp 46 in the same direction, thus focusing its light beam 34 in this downward direction. A light beam at this angle would allow rider to detect ground objects in its traveling path so as to avoid collision with them. Another advantage of an integrated lamp 46 in the frame 2 is that people driving cars at night in the opposite direction of the rider would see the frames 2 light beam and avoid colliding with the rider.

Another feature of the frame 2 that would be difficult for conventional bicycle frames to imitate would be the integration of an electronic display touch screen 1 which would display GPS mapping, heart rate, speed, time, date, calendar and an I-pod like device which would benefit riders as they rode the bike. Such a screen display 1 would be wide enough to be legible with touch screen capabilities and also water proof. Its surface should be flush with the surface of the frame 2 and extend from the left to right with a partial circumference of about 4 inches, wide and a length of about 5 inches.

### Advantages

The Lever Enhanced Pedaling System (LEPS) frame is wide compared to other bicycles, but this is due to the mechanical nature of the bike, being that it must accommodate a sprocket 36 centrally within each rear symmetrical portion. Furthermore, because torque from the lever machines 70 generate significant twisting force on the bike's frame 2, a wider central tube is needed to prevent the frame 2 from twisting during pedaling. The wider the frame diameter the stiffer the frame construction would be, because twisting force would be spread over a longer surface area. A wider frame 2 means that more electronic devices could be integrated into it, which would bond bicycling and information technology together. Thus, such an integration would keep bicyclist well connected with the rest of the world through integrated electronics like the Multi-Touch display LCD screen from Apple inc. or Zunes from Microsoft or an iphone like display within manual and visual range, which would allow the bicyclist to know how fast he or she was going, how to get to a particular destination through turn by turn directions and visual information of his or her cardiovascular system during cycling exercises. Furthermore, GPS could be included into the bicycle's frame 2 to track down the bike if it was stolen or to signal for help if the bicyclist was stranded out doors after a crippling accident. Police officers could use the integrated electronic device to run information on license plates, to look up the criminal record of a career criminal or to take notes at a crime scene. So these bikes would easily accommodate police patrolling.

In front of the stirring column would be an integrated head lamp which would help riders see obstacles and objects on the ground while bicycling at night. The frame design would be perfect for this feature because the front end of the frame is pointed at an angle towards the terrain, which would direct the light in that direction.

I claim:

1. A basic frame structure for a bicycle, which accommodates the use of two lever machines for propulsion, wherein the improvement comprises:
a central tube, bonded to a stirring cylinder, leading rearward from this connection to end below the seat;
two symmetrical tubes connected to said central tube directly at a leading first joint and indirectly at a second joint, wherein both symmetrical tubes lead rearwards to mount on the axle of the rear wheel;
the structure comprising said first joint of symmetrical tubes connection to the central tube and indirect second joint of symmetrical tubes connection to the central tube, which prevents each symmetrical tube from pivoting forwards from the rearward pull of separate member transmission chains by separate member high torque machines;
two said symmetrical tubes which are able to accommodate a member drive sprocket and meshed transmission chain within the cylinder walls of its lower tube portion and
at least one right plate member extended from the rear portion of said right symmetrical tube for accommodating the fulcrum of the right lever machine and at least one left plate member extended from the rear portion of said left symmetrical tube for accommodating the fulcrum of the left lever machine.

2. Said indirect connection of claim 1, which is composed of a plate member, centrally connected to the end of said central tube, wherein the rear facing part of the plate horizontally bridges the right symmetrical tube to the left symmetrical tube, while the front facing part of the plate horizontally bridges the right symmetrical tube to the central tube end and the central tube end to the left symmetrical tube, which ultimately prevents the symmetrical tubes from twisting clockwise or counter clockwise relative to the center point of the horizontal plate;

3. A basic frame structure of claim 1, wherein said symmetrical tubes have bottom ends with open grooves for accommodating the axel of the rear wheel and allowing the rear wheel to be dropped out;

4. A basic frame structure of claim 1, wherein said leading portion of the central tube can accommodate a forward beam head lamp;

5. A basic frame structure of claim 1, wherein said central tube has bonded to it a means for holding a seat post cylinder for holding the seat post tube for a seat;

6. A basic frame structure of claim 1, wherein each symmetrical tube has bonded to the bottom surface of its sloped tube portion at least one vertical plate with a bore for suspending a cylinder piston chamber for mechanical enhancement or for suspending its member lever machine above ground and

7. A basic frame structure of claim 1, wherein the central tube has the means to accommodate an integrated electronic device with a multi-touch display screen that is within visual and manual range of the bicyclist.
